(19) United States
(12) Patent Application Publication
(10) Pub. No.: US 2016/0232507 A1
(43) Pub. Date: Aug. 11, 2016

(54) SAVINGS NETWORK SYSTEM, METHOD AND ELECTRONIC PAYMENT DEVICE

(71) Applicant: Ding GU, Sewell, NJ (US)

(72) Inventor: Ding GU, Sewell, NJ (US)

(21) Appl. No.: 15/024,509

(22) PCT Filed: Sep. 30, 2014
(86) PCT No.: PCT/US14/58254

§ 371 Date: Mar. 24, 2016

Related U.S. Application Data
(60) Provisional application No. 61/884,168, filed on Sep. 30, 2013.

(51) Int. Cl. G06Q 20/20; G06Q 20/32; G06Q 20/34; G06Q 30/02; G06Q 20/38

(52) U.S. Cl. CPC G06Q 20/204; G06Q 30/0222; G06Q 30/0229; G06Q 30/0238; G06Q 20/387; G06Q 20/351; G06Q 20/32

(57) ABSTRACT

An embodiment of the present disclosure is a savings network that includes a plurality of different merchants that have arranged to apply a discount to a transaction initiated by cardholders that are members of the savings network.

### CROSS-REFERENCE TO RELATED APPLICATIONS

The present application claims priority to and the benefit of U.S. Provisional Application No. 61/884,168, filed Sep. 30, 2013, the entire contents of which are incorporated by reference into this document for all purposes.

### TECHNICAL FIELD

The present disclosure relates to a savings network of different merchants and an associated system, method, and electronic payment device.

### BACKGROUND

Consumers benefit from discounts applied to transaction for goods and services they purchase. To date, consumers can obtain discounts a number of ways through participation in so-called “Club” programs, e.g. “AAA”, and loyalty programs associated with a particular merchant. In club programs, the consumer receives a discount by way of membership in the club or network. The consumer presents a club card or club account number to the merchant at the time of purchase and the discount is applied to that purchase. Club programs are limited to select merchants associated with the club program. The consumer pays for membership in the club which must be renewed on yearly basis for continued participation in the club program. Other types of club programs allow the consumer to purchase goods and services from the club merchant locations, e.g. COSTCO, SAM's CLUB, or BJ's Wharehouse. Discounts through loyalty programs are obtained indirectly through continued purchases with a particular merchant that accrue points to the consumer account. The points accrued can be applied to acquire certain predetermined goods or services. Loyalty programs are limited to a particular merchant. An example of a loyalty program include airline miles associated with major airlines. Another type of loyalty program is associated with the use of credit cards. For instance, a Discover Card cardholder can accrue cash back for transactions completed with the “Discover Card.” A so called “cash back” amount, calculated as a percentage of the total value for transactions over year using the card, is credited the cardholder's balance. To date, consumers must be associated with a large number of club programs and a larger number of loyalty programs to obtain discounts across the widest number of merchants.

### SUMMARY

An embodiment of the present disclosure include a method that include a step accessing an electronic indication that a transaction at one of a plurality of merchant point-of-sale (POS) systems has been initiated via an electronic card associated with a cardholder. The cardholder may be a consumer or a business entity. Each merchant POS system can be associated with a different merchant, the electronic indication including at least one electronic cardholder identifier that represents the cardholder's account at a financial entity and the cardholder's membership in a savings network of the plurality of different merchants. Membership in the savings network entitles the cardholder to a discount in a total amount of the transaction initiated at the any one of the plurality of merchant POS systems. The method can also include the step of determining if the at least one electronic cardholder identifier corresponds to a savings network identifier associated with the cardholder and the merchant. The savings network identifier represents 1) the cardholder's membership in the savings network, 2) the merchant's membership in the savings network, and 3) the discount applicable to the transaction initiated at the merchant POS system. In response to the comparing step, if the at least one electronic cardholder identifier in the electronic card is corresponds to the savings network identifier, the method includes the step of causing the merchant POS system to automatically apply the discount to the total amount of the transaction so as to result in a discounted amount of the transaction at the particular merchant POS system where the transaction was initiated.

The accessing step can include receiving an electronic message from the one of the plurality of merchant POS systems that the transaction has been initiated via the electronic card associated with the cardholder. Further, the method can include transmitting an electronic message to the merchant POS system instructing the merchant POS to apply to the discount to the transaction. In variation of the accessing step, the accessing step includes retrieving from a computer memory of the merchant POS system the electronic indication that the transaction was initiated via the electronic card associated with the cardholder.

The method includes the step of transmitting an electronic message to request a payment for the discounted amount of the transaction to be transferred from the cardholder's account at the financial entity to the merchant's account at the same or a different financial entity.

The method includes the step of the step of storing in a computer memory of one or more of the plurality of merchant POS systems a software application, that when executed by the processor on the merchant POS system where the transaction was initiated, causes the merchant POS system to perform the step of comparing the at least one electronic cardholder identifier with the savings network identifier.

The discount can be between about 0.1% and 25% of the total amount of the transaction

One or more of the plurality of merchant POS systems is at a merchant location. And one or more of the plurality of merchant POS systems is a payment portal of a website. The payment portal can be associated with a payment processing entity.

Another embodiment of the present disclosure includes a system that includes at least one savings network computing device. The at least one savings network computing device. includes a computer memory having stored therein at least one electronic cardholder identifier associated with each one of a plurality of cardholders that are members of a savings network of a plurality if different merchants, an electronic merchant identifier associated with each one of a plurality of merchant POS systems that are associated with the respective plurality of different merchants, and a savings network identifier associated with the cardholder and the merchant. The at least one electronic cardholder identifier represents 1) the cardholder's account at a financial entity and 2) the cardholder's membership in the savings network of the plurality of merchants. The electronic merchant identifier represents A) each merchant's membership in the savings network and B) the discount applicable to the transaction. And the savings network identifier represents i) the cardholder's membership in the savings network, ii) the merchant's membership in the savings network, and iii) the discount applicable to the transaction initiated at the merchant POS system. The at least one savings network computing device is configured for electronic communication with each one of the plurality merchant POS systems so as to cause the discount applicable to transaction as indicated by the savings network identifier to be applied to the transaction initiated by the cardholder at the merchant POS system.

The computer memory includes stored thereon the at least one cardholder identifier, the electronic merchant identifier, and the savings network identifier. The at least one cardholder identifier, the electronic merchant identifier, and the savings network identifier are arranged in a database of the plurality of cardholders and the plurality of merchants stored in the computer memory. The at least one savings network computing device includes a software application stored on the computer memory and including instructions, that when executed by a processor, causes the processor to: access an electronic indication that the transaction has been initiated via an electronic card associated with the cardholder; determine if the at least one electronic cardholder identifier corresponds to the savings network identifier; and if the at least one electronic cardholder identifier corresponds to the savings network identifier, cause the merchant POS system to automatically apply the discount to a total amount of the transaction so as to result in a discounted amount of the transaction.

Another embodiment of the present disclosure is an electronic payment device configured to initiate a transaction with a merchant entity. The electronic payment device includes an electronic card having a non-transitory computer readable medium. Stored thereon is an electronic account number that is associated with a cardholder. The electronic account number includes a savings network identifier that represents the cardholder's membership in the savings network. The savings network includes a plurality of merchant point-of-sale systems each associated with a different merchant, wherein membership in the savings network entitles the cardholder to a discount applicable to the transaction initiated via the electronic card at any one of the plurality of merchant POS systems.

The electronic account number stored on the electronic payment device includes a bank account identifier that associates the cardholder with a checking account at a cardholder bank. Alternatively or in addition, the electronic account number stored on the electronic payment device includes a credit card account identifier that associates the cardholder with a credit account at a cardholder bank or a different bank. The electronic card is a software application running on a computing device. The computing device is a smart phone or a tablet.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is a process flow diagram for processing payments between a cardholder and a merchant each of which are associated with the savings network, according to an embodiment of the present disclosure;

FIG. 2 is a block diagramating the savings network according to an embodiment of the present disclosure;

FIG. 3 is an exemplary computing device of a savings network aggregator in the savings network shown in FIG. 2;

FIG. 4 is an exemplary point-of-sale system for a merchant according to an embodiment of the present disclosure;

FIG. 5 is a process flow diagram illustrating a method for applying a discount value to a transaction initiated by the cardholder at a merchant each of which are associated with the savings network;

FIG. 6 is a process flow diagram illustrating a method for applying discount value to a transaction according to another embodiment of the disclosure; and

FIG. 7 is a process flow diagram illustrating a method for applying a discount value to a transaction according to another embodiment of the disclosure.

### DETAILED DESCRIPTION OF ILLUSTRATIVE EMBODIMENTS

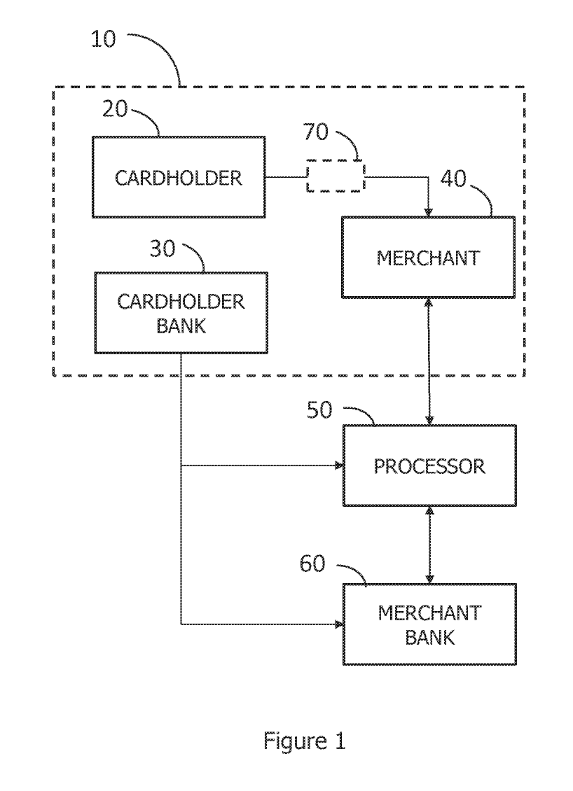

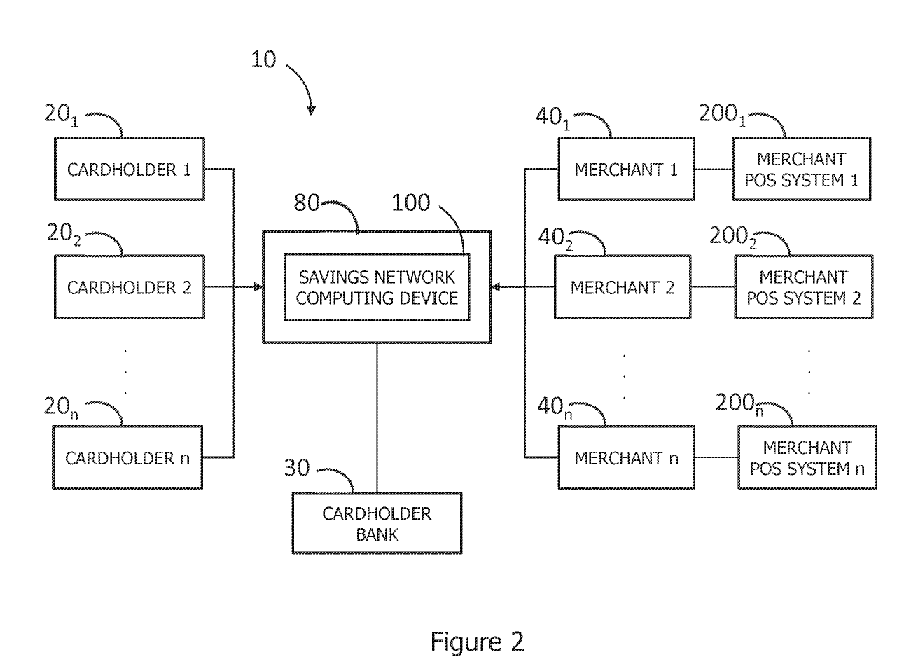

Referring to FIG. 1, an embodiment of the present disclosure is a savings network 10 that includes at least one cardholder 20 with an account held at a cardholder bank 30, a plurality of merchants 40. A cardholder may be consumer or business entity. A savings network aggregator 80 (see FIG. 2) aggregates a plurality of different merchants 40 each of which have arranged to apply a discount to a transaction initiated by cardholder 20 that are members of the savings network 10. The cardholder bank 30 can issue an electronic payment device 70 that the cardholder 20 can use to initiate the transaction for goods and/or services at the merchant 40 as will be further detailed below.

Continuing with FIG. 1, processing payments for a transaction initiated by the cardholder 20 at the merchant 40 includes participation by a payment processor 50, and a merchant bank 60. The cardholder tenders payment to the merchant 40 via the electronic payment device 70 for goods and/or services. In response, the merchant 40 sends a message to the processor 50. The processor 50 validates the account information conveyed to the merchant via the electronic payment device 70, as well as the ability of the cardholder to cover the amount required for the goods and/or services. The payment processor 50 can communicate with the cardholder bank 30 to verify any balance information (or credit of credit account). After the transaction amount is validated, the payment processor 50 sends a message to the merchant 40 to approve the transaction and complete the sale. Later, the payment processor 50 facilitates settling of payment from the cardholder bank 30 and the merchant bank 60. In accordance with an embodiment of the present disclosure, membership in the savings network 10 would entitle the cardholder 20 to a discount to the transaction that is applied at that the time the transaction is completed at the merchant 40. The discounted value will be sent to payment processor 50 for authorization and settlement.

Turning to FIG. 2, shown is the savings network 10 with a plurality of the cardholders 20₁, 20₂ . . . 20ₙ associated with the savings network aggregator 80, and a plurality of the merchants 40₁, 40₂, . . . 40ₙ. Each merchant 40 includes a respective merchant point-of-sale (POS) system 100. The savings network 10 can be said to include a plurality of different merchant POS systems 200₁, 200₂, . . . 200ₙ. Each merchant 40₁ is different from the other merchant 40₂. Thus, each merchant POS 200₁ is different from other merchant POS system 100₂. The cardholder 20 pays a fee to the network aggregator 80 for membership in the savings network 10 as further detailed below. Further details regarding the electronic payment device 70 are described below.

Each merchant 40 determines the discount applicable to the transaction. An incentive to encourage merchants to join the savings network 10 will be providing marketing and advertising through savings network aggregator's website and other materials. The savings network 10 can be expanded through a merchants direct engagement with consumers or businesses.

Because the savings network 10 includes a plurality of different merchants 40, the cardholder benefits from obtaining a discount across a larger number of merchants. For instance, if the merchants include a grocery store, department store, and gas station, the cardholder obtains discount at the grocery store, the department store, and gas station through use of a single electronic payment device 70 (FIG. 1). In prior discount programs, the cardholder would need to participate in individual loyalty programs with the grocery store, department store, and gas station to obtain a benefit. In prior discount programs, the benefit is deferred until a threshold amount of points or the like are met, but using in using the savings network 10, the cardholder obtains the discount at the time of the transaction.

Before enrolling for savings network, the potential member is advised of a recurring annual fee. This fee will be automatically charged after a pre-determined trial period. The cardholder bank 30 can automatically deduct this fee from the cardholder's account at a predetermined interval, such as annually or bi-annually. The membership fee is then transferred to a bank associated with the network aggregator 80. The recurring membership fee will be deducted, in predetermined intervals, until the cardholder's membership in the savings network 10 is cancelled.

The cardholder bank 30 can issue the electronic payment device 70 which is configured to initiate a payment transaction with a merchant 30. The electronic payment device 70 can be a readable card that is used to initiate a transfer of funds from the cardholder's account held by the cardholder bank 30 to the merchant bank 60 as payment for the good or services. The readable card includes a memory portion, typically a magnetic stripe, having stored thereon an electronic account number associated with the cardholder 20. The electronic account number includes a number of electronic identifiers, such as a savings network identifier, a bank account identifier and, alternatively, a credit card account identifier. The savings network identifier represents the cardholder's membership in the savings network, the discount applicable to the transaction initiated at the merchant POS system. In other implementations, the savings network identifier also represents a merchants’ membership in the savings network. The savings network identifier thus indicates the cardholder's entitlement to a discount applicable to the transaction initiated by the cardholder at any one of the plurality of merchant POS systems 200. The discount may be between 0.1% (or some amount greater than zero) and about 25% or more of the total amount of the transaction. The discount can be applied before or after taxes, if applicable. The bank account identifier associates the cardholder with a checking account at a cardholder bank 30. The credit card account identifier associates the cardholder with a credit account at a cardholder bank or institution. In accordance with the alternate embodiment, the readable card can be an application running on a computing device, such a smart phone or tablet. It should be appreciated that the savings network aggregator 80 can be a financial entity, such as the cardholder bank 30.

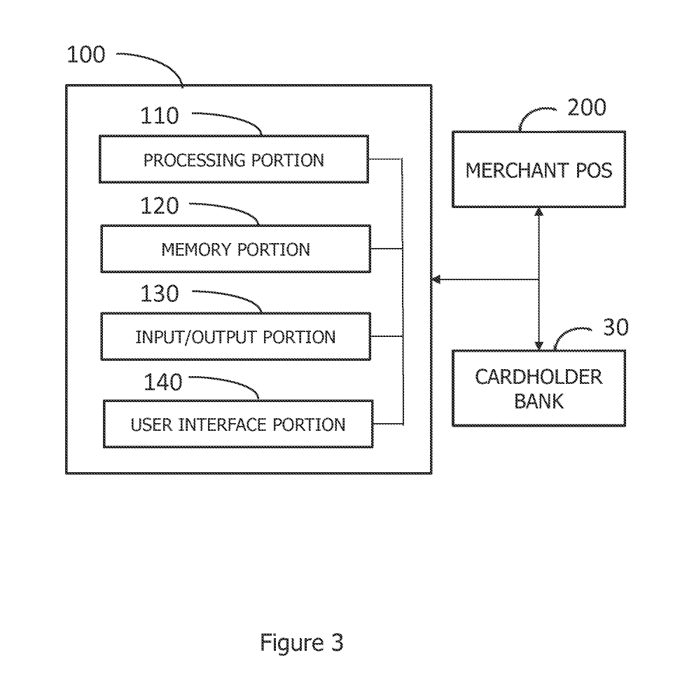

Turning now to FIG. 3, the savings network aggregator 80 can operate one savings network computing device 100 to manage the savings network 10 and interaction with merchant POS system 200. The savings network computing device 100 can be in electronic communication with the merchant POS system 200 and the cardholder bank 30 via communications network. The savings network computing device 100 can be configured as an exemplary computing device that is configured to receive and process cardholder account information, e.g. cardholder account numbers, merchant information, and savings network information. It will be understood that the computing device 200 can include any appropriate device such as a desktop computing device, a server computing device, or a portable computing device, such as a laptop, tablet or smart phone.

As illustrated, the savings network computing device 100 can include a processing portion 110, a memory portion 120, a user interface 130, and an input/output portion 140. It is emphasized that the block diagram depiction of the computing device 100 is exemplary and not intended to imply a specific implementation and/or configuration. The processing portion 110, a memory portion 120, a user interface 130, and an input/output portion 140, can be coupled together to allow communications therebetween. Further, any of the above components may be distributed across one or more separate devices and/or locations.

The processing portion 110 is configured to execute applications stored in the memory portion 120 so as to operate the savings network computing device 100. The processing portion 110, when implementing the savings network software application described below, facilitates the efficient transmission of data among and between the merchant POS system and cardholder bank 30. For instance, the processing portion 110 running the savings network software application can efficiently validate transactions initiated by the cardholder at a particular merchant while not significantly increasing the processing time required to authorize and settle payments between the cardholder bank 30 and the merchant bank 60 (bank 30 and 60 shown in FIG. 1).

The memory portion 120 of the savings network computing device 100 has stored therein cardholder information, merchant information, savings network information, and one or more of the savings network software applications. The cardholder information can be in form of electronic identifiers that represent each one of the plurality of cardholder's accounts at the cardholder bank 60 and the cardholder's membership in the savings network 10. For instance, the computer memory 120 includes stored thereon an electronic cardholder identifier that represents a cardholder's account at the cardholder bank 30. The electronic cardholder identifier also represents the cardholder's membership in the savings network 10.

The computer memory 120 may also include a savings data for each cardholder. The savings data represents the total amount of savings the cardholder obtained for participating in the savings network. For instance, the savings data is a running total for discounts applied to all the transactions initiated by the cardholder for each participating merchant where the cardholder purchased goods and/or services.

The merchant information can be in the form of electronic identifiers that represent each one of the plurality of merchants 40 associated with the savings network 10 and each merchant POS system 200. For instance, the computer memory 120 includes stored thereon an electronic merchant identifier that corresponds to each merchant..

The savings network information can be in the form of electronic identifiers that represents the plurality of merchant's association with the savings network 10. For instance, the savings network information can include one more saving network identifiers. The savings network identifier represents 1) the cardholder's membership in the savings network, 2) the merchant's membership in the savings network, and 3) the discount applicable to the transaction initiated at a particular merchant POS system. Discounts may differ among each merchants. Each merchant largely determines the discount it is willing to offer to members of the savings network 10. For instance, Walgreen's may apply a 5% discount to a transaction initiated by cardholder 20 whereas Wal-Mart may apply a 1% discount to a transaction initiated by cardholder 20.

The electronic merchant identifier, the electronic cardholder identifier, and the savings network identifiers can be arranged in a database stored in the computer memory 120 of the savings network computing device 100. The database can be savings network database of plurality of cardholders and the plurality of merchants that are members of the savings network 10.

Depending upon the exact configuration and type of processor 110, the memory portion 120 can be volatile (such as some types of RAM), non-volatile (such as ROM, flash memory, etc.), or a combination thereof. The computing device 100 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the computing device 100.

The savings network computing device 100 can contain the user interface portion 130, which can include an input device and/or display (input device and display not shown), that allows a user to communicate with the computing device 100. The user interface 130 can include inputs that provide the ability to control the computing device 100, via, for example, buttons, soft keys, a mouse, voice actuated controls, a touch screen, movement of the computing device 100, visual cues (e.g., moving a hand in front of a camera on the computing device 100), or the like. The user interface 130 can provide outputs, including visual information, such as the visual indication of the members of the savings network, the merchant members of the savings network. Other outputs can include audio information (e.g., via speaker), mechanically (e.g., via a vibrating mechanism), or a combination thereof. In various configurations, the user interface 130 can include a display, a touch screen, a keyboard, a mouse, an accelerometer, a motion detector, a speaker, a microphone, a camera, or any combination thereof. The user interface 130 can further include any suitable device for inputting biometric information. The biometric information for access to the savings network computing device 100 can be for example, fingerprint information, retinal information, voice information, and/or facial characteristic information.

The input/output portion 140 includes a receiver of the computing device 100, a transmitter the computing device 100, or an electronic connector for wired connection, or a combination thereof. The input/output portion 140 is capable of receiving and/or providing information pertaining to communication with a network such as, for example, the Internet. Transmit and receive functionality may also be provided by one or more devices external to the computing device 100.

An exemplary architecture can include one or more savings network computing devices 100, each of which can be in electronic communication with the merchant POS system 200 and cardholder bank 30 via common communications network. It should be appreciated that numerous suitable alternative communication architectures are envisioned. Once the saving network application has been installed onto the computing device 100, such as described above, the savings network application can transfer information between and among the savings network computing devices 100 and the merchant POS system 200 linked to the communications network, such as, for example, the Internet. For instance, in one configuration, a user may transmit, or cause the transmission of information via the communications network regarding one or more cardholders 20 to the merchant POS system 200, or alternatively to a computing device of another third party, e.g., a payment processor and/or the cardholder bank 30, via the communications network. It should be appreciated that “access” or “accessing” as used herein can include retrieving information stored in the memory portion of the local computing device, or sending instructions via the network to a remote computing device so as to cause information to be transmitted to the memory portion of the local computing device for access locally. In addition or alternatively, accessing can include accessing information stored in the memory portion of the remote computing device 100. The computing device 100 may be operated in whole or in part by, for example, the network aggregator 80.

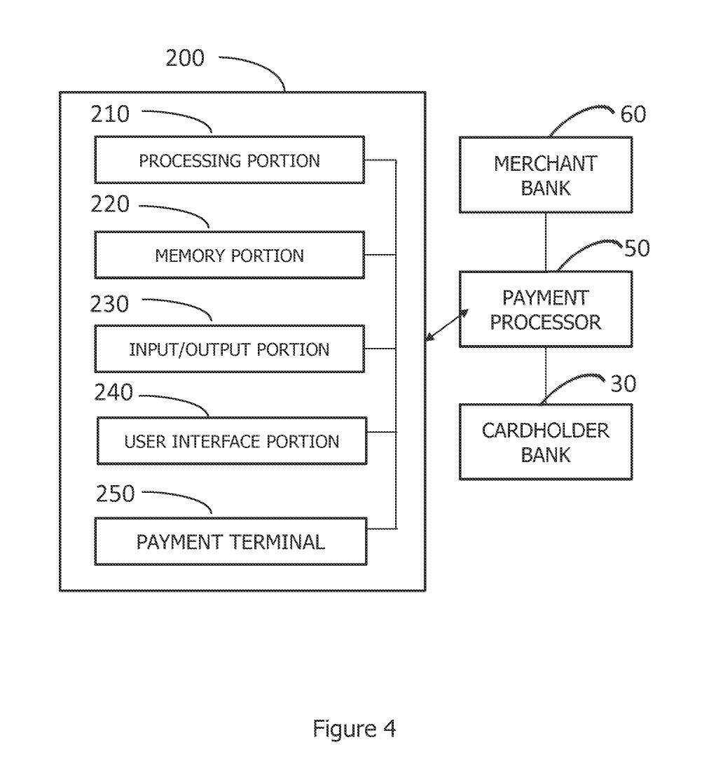

Turning now to FIG. 4, the merchant POS system 200 can include a processing portion 210, a memory portion 220, a user interface 230, an input/output portion 240, and a payment terminal 250. As such, the merchant POS system 200 can be any exemplary computing device configured to receive payment and record transactions for goods and services between a cardholder and the merchant. The merchant POS system 200 include any appropriate computing device, such as a desktop computing device, a server computing device, or a portable computing device, e.g. as a laptop, tablet or smart phone, connectable to the payment terminal 250. For instance, the merchant POS 200 can include one or more hardware units, such as a housing for the display unit that can be associated with a cash drawer for processing cash payments. One or more of the components of the POS system 200 can be coupled to one or more separate computing devices communicatively coupled together over a communications network. Further, the merchant POS system can be configured as a payment portal on the merchant's website. Alternatively, the merchant POS system can be configured as a payment portal running as a frame through the merchant's website yet operated by the 3^{rd} party payment processor, such as Paypal.

The processing portion 210 is configured to execute applications stored in the memory portion 220 so as to operate the each merchant POS system 200. The processing portion 210 can execute the savings network software application described above when the savings network application is stored on the memory portion 220 of the merchant POS system. As described above with respect to savings network computing device, the processing portion 210 running the savings network software application can efficiently validate transactions initiated by the cardholder via the payment terminal 250 at merchant POS system while not significantly increasing the processing time required by the merchant POS system 200 to authorize payments between the cardholder bank 30 and the merchant 40.

The memory portion 220 of the merchant POS system 200 has stored therein at least merchant information, as well as software applications for running the merchant POS system 200. In embodiments where the merchant POS system 200 validates the cardholder's membership in the savings network 10 and entitlement to the discount, the memory portion 220 can include savings network information and one or more of the savings network software applications. The savings network information can be similar to the savings network information described above with respect to the savings network computing device 100. As such, in certain embodiments, the memory portion 220 of the merchant POS system 200 can include the savings network identifier that represents 1) a merchant's membership in the savings network 10, and 2) a discount applicable to a transaction initiated at that particular merchant POS system. Depending upon the exact configuration and type of processor 220, the memory portion 220 can be volatile, non-volatile, or a combination thereof. The merchant POS system 200 can include additional storage (e.g., removable storage and/or non-removable storage) as described above with respect to savings network computing device 100, or any other medium which can be used to store information and which can be accessed by the merchant POS system 200.

The user interface portion 230 of the merchant POS system 200 can include a merchant input device and a display that allows a user to communicate with the merchant POS system 200. The input device allows a user to enter various input that can control operation of the merchant POS system 200. The input device can include keys, key pads, buttons, soft keys, a mouse, voice actuated controls, a touch screen, movement of the computing device 200, visual cues (e.g., moving a hand in front of a camera on the computing device 200), or the like, scanner, such as a bar code or QR code scanner. The user interface 230 can provide outputs, including visual information, such as the visual indication of the items or services acquired by the cardholder, cardholder information, and/or savings network information. Other outputs can include audio information, mechanical, (e.g., via a vibrating mechanism), or a combination thereof. In various configurations, the user interface 230 can include a display, a touch screen, a keyboard, a mouse, an accelerometer, a motion detector, a speaker, a microphone, a camera, or any combination thereof. The user interface 230 can further include any suitable device for inputting biometric information, such as, for example, fingerprint information, retinal information, voice information, and/or facial characteristic information, for instance, so as to require specific biometric information for access to the merchant POS system 200.

The input/output portion 240 include a receiver of the merchant POS 200, a transmitter the merchant POS system 200, an electronic connector for wired connection, or a combination thereof. The input/output portion 240 is capable of receiving and/or providing information pertaining to communication with a network such as, for example, the Internet. As should be appreciated, the transmit and receive functionality may also be provided by one or more devices external to the merchant POS system 200. Accordingly, the input/output portion 240 can be coupled to the communications network, WAN, LAN or other type of network architecture. Accordingly, the merchant POS system 200 can be in electronic communication with the processor 50 and/or the savings network aggregator 80, and indirectly or directly in electronic communication with the cardholder bank 30 and the merchant bank via a processor network 90. A user may transmit, or cause the transmission of information via the communications network regarding one or more cardholders 20 to the merchant POS system 200, or alternatively to a computing device of another third party, e.g., a payment processor 50 and/or the cardholder bank 30, via the communications network. It should be appreciated that “access” or “accessing” as used herein can include retrieving information stored in the memory portion of the merchant POS system 200, or sending instructions via the network to a remote computing device so as to cause information to be transmitted to the memory portion of the local computing device for access locally. In addition or alternatively, accessing can include accessing information stored in the memory portion of the remote POS system. The merchant POS system 200 may be operated in whole, or in part by, for example, the merchant.

The payment terminal 250 is a device configured to read the electronic payment device 70. In accordance with an illustrated embodiment, the electronic payment device 70, is a readable card. The payment terminal can be configured to read the magnetic portion of the readable card 70 issued to the cardholder 20 by the cardholder bank 30. The payment terminal 260 can be card reader electronically coupled to user interface portion 230 such that information stored in the readable card 70 can be transmitted to the processor portion 220 of the merchant POS system 200. The processor 220 can cause information stored on the readable card to be transmitted to the processor 50 and/or network aggregator over the communications network. The information can then be routed to the cardholder bank 30. The merchant POS system 200 can receive authorization to complete the transaction. In another embodiment, the payment terminal can be a QR code reader, bar code, scanner, a payment portal running on website, or any other device configured to receive information from the electronic payment device 70.

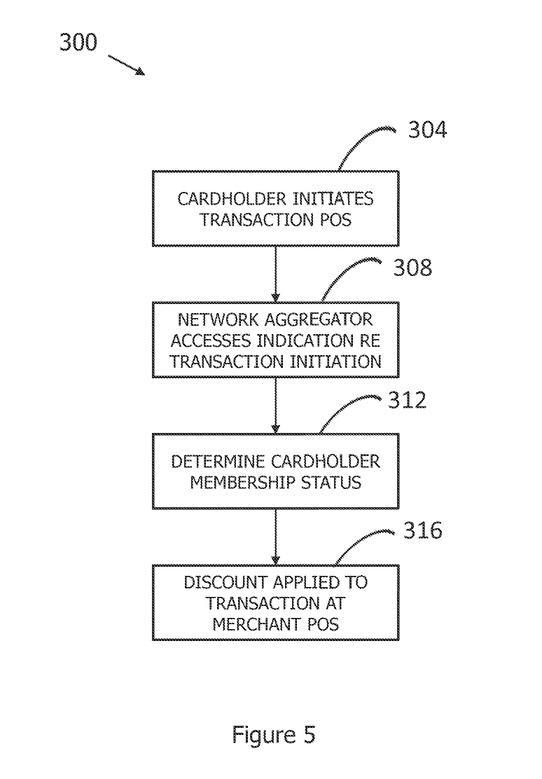

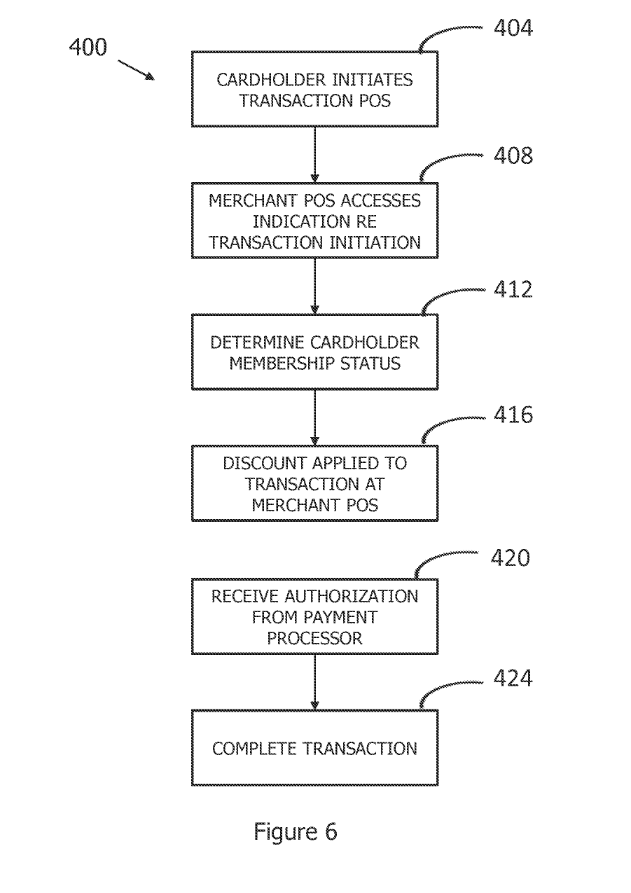

The savings network computing device 100 can be in electronic communication with each one of the plurality merchant POS systems 200 so that the merchant POS system automatically applies the discount to the transaction when the cardholder initiates the transaction at the particular merchant POS system 200. In an embodiment of the present disclosure, the savings network aggregator 80, via the savings network computing device 100, can validate cardholder's membership in the savings network and determine if the discount is applicable to the transaction and cause the merchant POS system 200 to automatically apply the discount. The process whereby the savings network aggregator 80 validates the cardholder's membership in the savings network 10 is illustrated in FIG. 5 and is further described below. In an alternative embodiment of the present disclosure, the merchant POS system 200 can validate cardholder's membership in the savings network and determine if discount is applicable to the transaction so as to automatically apply the discount to the transaction. The process whereby the merchant 40 validates the cardholder's membership in the savings network 10 is illustrated in FIG. 6 and is further described below. In any event, whether network aggregator 80, the merchant 40, or processor 50 validates cardholder membership in the savings network and determines if discount is applicable to the transaction, communications among and between the savings network device 200 and the merchant POS system 200 is such that the merchant POS system can automatically apply the discount to the transaction if the cardholder is determined to be a member of the savings network 10.

Turning now to FIG. 5, a method 300 whereby the savings network aggregator 80 validates the cardholder's membership in the savings network 10 and determines the discount applicable to the transaction is illustrated. In performing the steps of the method 300, the savings network computing device 100 runs the savings network software application stored on the computer memory 120. The method 300 initiates in block 304 when the cardholder 30 presents the electronic payment device 70 to the merchant POS system 100. In block 308, the savings network aggregator 80 can access an electronic indication that the transaction has been initiated via the electronic card 70 associated with the cardholder 20. Access can include receiving an electronic message that the transaction has been initiated via the electronic card 70. The electronic indication includes at least one electronic cardholder identifier. As noted above, the at least one electronic cardholder identifier represents the cardholder's account at the cardholder bank 30 and the cardholder's membership in a savings network 10. Process control is transferred to block 312.

In block 312, the processor 110, running the savings network software application, determines if the at least one electronic cardholder identifier received from the merchant POS system 200 corresponds to the savings network identifier. As noted above, the savings network identifier represents the savings network identifier represents 1) the cardholder's membership in the savings network, 2) the merchant's membership in the savings network, and 3) the discount applicable to the transaction initiated at the merchant POS system. Process control is transferred to block 316. If the processor determines that the electronic cardholder identifier in the electronic card corresponds to the savings network identifier, the processing portion 110 can cause the merchant POS system 100 to automatically apply the discount to a total amount for the transaction so as to result in a discounted transaction amount at the merchant POS system where the transaction as initiated. In particular, process control can be transferred to block 316, whereby the savings network aggregator 80 can transmit an electronic message to the merchant POS system 200 instructing the merchant 40 to apply the discount. Alternatively, the electronic message can, when received by the merchant POS system 200, store an executable file in the memory portion 220 of the merchant POS system that causes the merchant POS system 200 to apply the discount to the transaction. The electronic message can transmitted to the merchant POS system 200 along with or in addition to any message the merchant POS system 200 receives from the payment processor 50 authorizing the transaction for the desired amount.

In another embodiment, a third party payment processor can validate cardholder's membership in the savings network 10 and determine if the discount is applicable to the transaction and is similar to process 300 illustrated in FIG. 5.

Turning now to FIG. 6, a method 400 whereby the merchant 40 validates the cardholder's membership in the savings network 10, determines the discount applicable to the transaction, and applies the discount. In performing the steps of the method 400, the merchant POS system 200 includes the ability to run the savings network software application off of the computer memory 220 of the merchant POS system 200, or runs the savings network application via a web application. In an any event, when the savings network application has been installed on the merchant POS system 200, the savings network application can transfer information between and among the savings network computing devices 100 and the merchant POS system 200.

The method 400 initiates in block 404 when the cardholder 30 presents the electronic payment device 70 to the merchant POS system 200. In block 408, the merchant POS system 200 accesses an electronics indication that a transaction has been initiated via the electronic payment device 70 associated with the cardholder 20. Access can include retrieving the electronic indication from the memory portion in response to the electronic payment device 70 engaging the payment terminal 250. Because the electronic payment device 70 includes the electronic cardholder identifier, which represents the cardholder's account at the cardholder bank 30 and the cardholder's membership in a savings network 10. Process control is transferred to block 412.

In block 412, the processor 210, running the savings network software application, determines if the at least one electronic cardholder identifier corresponds to the savings network identifier. As noted above, the savings network identifier represents savings network identifier represents the savings network identifier represents 1) the cardholder's membership in the savings network, 2) the merchant's membership in the savings network, and 3) the discount applicable to the transaction initiated at the merchant POS system. Process control is transferred to block 416. If the processor 210 determines that the electronic cardholder identifier in the electronic card corresponds to the savings network identifier, the processing portion 210 automatically applies the discount to the transaction. In particular, the merchant 40 can transmit an electronic message to the processor 50 requesting authorization for the amount of the transaction discounted at the merchant POS system 200. Process control is transferred to block 420.

In block 420, the merchant POS system 200 receives an electronic message from the payment processor 50 that indicates that the transaction for the amount requested, and discounted, is authorized. Process control is transferred to block 424. In block 424, the merchant POS system 200 completes the transaction at the discounted amount.

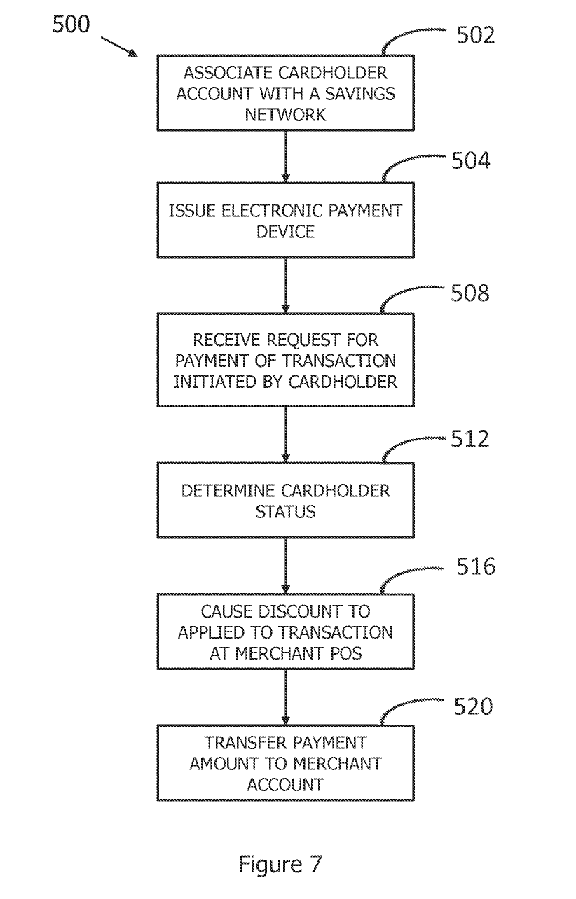

Turning to FIG. 7, a method 500 whereby the savings network aggregator 80 is also the cardholder bank 30. In such an embodiment, the cardholder bank 30 operates the savings network computing device. In such an embodiment, the cardholder bank 30 issues the electronic payment device 70 and also validates the cardholder's membership in the savings network 10 and determines the discount applicable to the transaction. In performing the steps of the method 500, the savings network computing device 100 runs the savings network software application stored on the computer memory 120. The method includes in block 502, the step of associating the cardholder's account with the savings network 10 of different merchants.

In block 504, the cardholder bank 30 issues an electronic card to a cardholder 20. As noted above, the electronic card 70 includes a memory having stored thereon information identifying a cardholder 20, such as an electronic account number that is associated with a cardholder. The electronic account number includes a savings network identifier that represents the cardholder's membership in the savings network 10. As noted above, membership in the savings network entitles the cardholder to a discount at transactions initiated at any of the plurality of merchants 30. Each one of the plurality of merchants 30 is associated with a respective merchant POS system 200 configured to receive payment via the electronic card 70. Processing control is transferred to block 508.

In block 508, the cardholder bank 30 receives a request from the merchant POS system 200, via the payment processor 50, for payment for a discounted transaction to be transferred from the cardholder's account at the cardholder's bank to an account associated with the merchant. The merchant account can be at the cardholder's bank or can be a different financial entity. In block 512, the processor 110, running the savings network software application, determines if the at least one electronic cardholder identifier received from the merchant POS system 200 corresponds to the savings network identifier. Process control is transferred to block 516. In block 616, if the processor determines that the electronic cardholder identifier to the savings network identifier, the processing portion 110 can cause the merchant POS system 100 to automatically apply the discount to the transaction so as to result in a discounted transaction value. For instance, the cardholder bank 30 can transmit an electronic message, via the processor 50, to the merchant POS system 200 instructing the merchant 40 to apply the discount. Alternatively, the electronic message can, when received by the merchant POS system 200, store an executable file in the memory portion 220 of the merchant POS system that causes the merchant POS system 200 to apply the discount to the transaction. The electronic message can transmitted to the merchant POS system 200 along with or in addition to any message the merchant POS system 200 receives from the payment processor 50 authorizing the transaction for the desired amount. Process control is transferred to block 52. In block 520, the cardholder bank 30 can cause the amount for the transaction to be transferred from the cardholders account to the merchant's account. The method can also include, causing a fee to deducted from the cardholder account, the fee being exchanged for cardholder's participation in the network.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

We claim:

1. A method comprising:
a. accessing an electronic indication that a transaction at one of a plurality of merchant point-of-sale (POS) systems has been initiated via an electronic card associated with a cardholder, each merchant POS system being associated with a different merchant, the electronic indication including at least one electronic cardholder identifier that represents the cardholder's account at a financial entity and the cardholder's membership in a savings network of the plurality of different merchants, wherein membership in the savings network entitles the cardholder to a discount in a total amount of the transaction initiated at the any one of the plurality of merchant POS systems;
b. determining if the at least one electronic cardholder identifier corresponds to a savings network identifier associated with the cardholder and the merchant, the savings network identifier representing 1) the cardholder's membership in the savings network, 2) the merchant's membership in the savings network, and 3) the discount applicable to the transaction initiated at the merchant POS system;
c. in response to the comparing step, if the at least one electronic cardholder identifier in the electronic card is corresponds to the savings network identifier, causing the merchant POS system to automatically apply the discount to the total amount of the transaction so as to result in a discounted amount of the transaction at the particular merchant POS system where the transaction was initiated.

2. The method of claim 1, wherein the accessing step includes receiving an electronic message from the one of the plurality of merchant POS systems that the transaction has been initiated via the electronic card associated with the cardholder.

3. The method of claim 2, further comprising the step of transmitting an electronic message to the merchant POS system instructing the merchant POS to apply to the discount to the transaction.

4. The method of claim 1, wherein the accessing step includes retrieving from a computer memory of the merchant POS system the electronic indication that the transaction was initiated via the electronic card associated with the cardholder.

5. The method of claim 1, further comprising the step of transmitting an electronic message to request a payment for the discounted amount of the transaction to be transferred from the cardholder's account at the financial entity to the merchant's account at the same or a different financial entity.

6. The method of claim 6, further comprising the step of storing in a computer memory of one or more of the plurality of merchant POS systems a software application, that when executed by the processor on the merchant POS system where the transaction was initiated, causes the merchant POS system to perform the step of comparing the at least one electronic cardholder identifier with the savings network identifier.

7. The method of claim 1, wherein the discount is between about 0.1% and 25% of the total amount of the transaction.

8. The method of claim 1, wherein one or more of the plurality of merchant POS systems is at a merchant location.

9. The method of claim 1, wherein one or more of the plurality of merchant POS systems is a payment portal of a website.

10. The method of claim 1, wherein the payment portal is associated with a payment processing entity.

11. A system comprising:
at least one savings network computing device including a computer memory having stored therein at least one electronic cardholder identifier associated with each one of a plurality of cardholders that are members of a savings network of a plurality if different merchants, an electronic merchant identifier associated with each one of a plurality of merchant POS systems that are associated with the respective plurality of different merchants, and a savings network identifier associated with the cardholder and the merchant,
wherein the at least one electronic cardholder identifier represents 1) the cardholder's account at a financial entity and 2) the cardholder's membership in the savings network of the plurality of merchants, and the electronic merchant identifier represents A) each merchant's membership in the savings network and B) the discount applicable to the transaction, and the savings network identifier represents i) the cardholder's membership in the savings network, ii) the merchant's membership in the savings network, and iii) the discount applicable to the transaction initiated at the merchant POS system,
wherein the at least one savings network computing device is configured for electronic communication with each one of the plurality merchant POS systems so as to cause the discount applicable to transaction as indicated by the savings network identifier to be applied to the transaction initiated by the cardholder at the merchant POS system.

12. The system of claim 11, computer memory includes stored thereon the at least one cardholder identifier, the electronic merchant identifier, and the savings network identifier.

13. The system of claim 12, wherein the at least one cardholder identifier, the electronic merchant identifier, and the savings network identifier are arranged in a database of the plurality of cardholders and the plurality of merchants stored in the computer memory.

14. The system of claim 11, further comprising a software application stored on the computer memory and including instructions, that when executed by a processor, causes the processor to:
access an electronic indication that the transaction has been initiated via an electronic card associated with the cardholder;
determine if the at least one electronic cardholder identifier corresponds to the savings network identifier; and
if the at least one electronic cardholder identifier corresponds to the savings network identifier, cause the merchant POS system to automatically apply the discount to a total amount of the transaction so as to result in a discounted amount of the transaction.

15. A electronic payment device configured to initiate a transaction with a merchant entity, comprising:
an electronic card including a non-transitory computer readable medium having stored thereon an electronic account number that is associated with a cardholder, the electronic account number including a savings network identifier that represents the cardholder's membership in the savings network, wherein the savings network including a plurality of merchant point-of-sale systems each associated with a different merchant, wherein membership in the savings network entitles the cardholder to a discount applicable to the transaction initiated via the electronic card at any one of the plurality of merchant POS systems.

16. The electronic payment device of claim 15, wherein the electronic account number includes a bank account identifier that associates the cardholder with a checking account at a cardholder bank.

17. The electronic payment device of claim 15, wherein the electronic account number includes a credit card account identifier that associates the cardholder with a credit account at a cardholder bank or a different bank.

18. The electronic payment device of claim 15, wherein the electronic card is a software application running on a computing device.

19. The electronic payment device of claim 18, wherein the computing device is a smart phone or a tablet.
